(19) United States
(12) Patent Application Publication
(10) Pub. No.: US 2015/0294021 A1
(43) Pub. Date: Oct. 15, 2015

(54) System and Method for Creating A Computational Bookmarking Icon

(71) Applicant: Zachary Schwartz, Jacksonville, FL (US)

(72) Inventor: Zachary Schwartz, Jacksonville, FL (US)

(21) Appl. No.: 14/683,884

(22) Filed: Apr. 10, 2015

Related U.S. Application Data
(60) Provisional application No. 61/978,234, filed on Apr. 11, 2014.

(51) Int. Cl. G06F 17/30; G06Q 30/02; G06F 3/0484

(52) U.S. Cl. CPC G06F 17/30882; G06F 3/04847; G06F 3/04842; G06Q 30/0267

(57) ABSTRACT

Systems, methods, and computer program products are provided that allow host web sites to enable vendor landing pages from those web sites to be associated with automatically generated custom vendor icon bookmarks for addition to the display screen (e.g., home screen) of a user computing device when a user accesses the vendor landing page, and especially to generate a plurality of such generated custom vendor icon bookmarks for addition to the home screen of the user's computing device.

### CROSS REFERENCE TO RELATED APPLICATION

This application claims the benefit of U.S. Provisional Patent Application Ser. No. 61/978,234, filed Apr. 11, 2014, and entitled “System and Method for Bookmarking Vendor Landing Page on Host Web Site,” the entire contents of which are incorporated herein by reference.

### FIELD OF THE DISCLOSURE

The present disclosure relates to storing computational file addresses, and more particularly to systems, methods, and computer program products for creating a graphical representation of one or more stored computational file addresses.

### BACKGROUND

One of the fastest growing uses of the Internet is as a vehicle of commerce. World-wide access achieved by use of the Internet makes it ideal for many small and large businesses (hereafter referred to as “vendors”) to offer their goods and/or services for sale, distribution, marketing, etc. As a result, the products and/or services available to users of the Internet are considerable and are growing more so every day. Because users may need to locate products and/or services of interest from the vast number of web sites, vendors may also need to distinguish themselves from competition to attract and retain such users of the Internet as customers.

Web sites on the Internet are electronically connected or linked together using special communication protocols such as, for example, Hypertext Transport Protocol (HTTP), and Uniform Resource Locators (URLs) which include a specific syntax for defining a network connection on the Internet. HTTP permits an exchange of information between Internet users and web sites which may contain subject matter of interest (e.g., products and/or services) to the users. From a user's prospective, the Internet may appear as a collection of viewable documents, or web pages, residing at the various web sites. Accordingly, users of the Internet require tools for accessing, selecting, retrieving, etc., amongst these various web sites.

Access to the Internet often requires a software tool referred to as a web browser (often just called a “browser”), which is installed on the user's device to access the Internet. Browsers include text based line browsers, graphical based browsers such as Internet Explorer, Google Chrome, Mozilla Firefox, Safari, etc. A browser running on the user's device electronically sends instructions (which may include the URL of the desired web site, word criteria for web sites of interest, etc.) for connecting to a specified host web site, for searching for web sites of interest, etc., and which may reside on one or more web servers which store the web pages which may be of interest to the user. In other words, a browser may be used to navigate the World Wide Web (i.e., the system of interlinked hypertext documents accessible on the Internet), in order to access web pages of a web site of interest. But even when armed with such search tools, locating and retrieving information on products and/or services of interest from the many hundreds of thousands of web sites currently operating over the Internet may be burdensome. For example, the search results (commonly referred to as a “hits list”) obtained by such searches may yield so many web sites that the effort to review the ‘hits list” and narrow the search may be time consuming and difficult.

To distinguish their goods and/or services on the Internet, vendors may engage in a form of web based advertising that utilizes special web sites and/or web pages commonly referred to as “landing pages,” “lead capture pages,” “landers,” etc. (hereafter referred to collectively as “landing pages”) which may be contain links that direct users to the vendor's web site. When a given link is selected (e.g., “clicked on”) the browser may be directed to the vendor's web site where further information regarding the vendor's goods/services may be displayed. Such vendor landing pages may be delivered to users, for example, in interactive, online environments based on a variety of factors such as a user's known and/or inferred interests, the particular web page(s) which the user may be viewing, terms the user may be searching for, the prior user history with respect to the user selecting a vendor landing page, etc. Such vendor landing pages may also be stored on a host web site which administers, manages, controls, etc., access to, as well as the display of those vendor landing pages.

Features also exist for storing the electronic address (i.e., the URL) of a web page, such as a landing page, currently being displayed. One such feature is commonly referred to as a “bookmark,” and provides an electronic link or short cut to the web page being accessed. Bookmarks eliminate the need for the user to manually enter the URL of a web page of interest or to retrace (re-navigate) a path through the Internet to arrive at that web page through a known link. In other words, bookmarks, once created, offer the ability to retrieve the URL of a particular web page, as well as directing the user's browser to display the web page residing at the URL. Accordingly, bookmarks also provide the ability for vendors to have users store their respective landing pages for subsequent access by those users.

Currently, when bookmarking web pages such landing pages on the Internet, a user may be offered a “default” bookmark icon which may be a “screen shot” of the particular landing page being bookmarked. Alternatively, the user may be offered a generic icon for creating the bookmark which provides no ability to graphically differentiate that bookmark (other than by an alphanumeric name, symbol, text, etc.) from any other bookmark. When such default or generic icons are utilized, the user, when bookmarking several vendor landing pages from a host web site (or several web pages within or associated with a particular vendor landing page), would, at best, be provided on their computing device's display screen (e.g., home screen) graphically indistinct duplicates of the same default or generic icon for each of those bookmarks as a hyperlink (short cut) to those selected vendor landing pages (or web pages within or associated with a particular vendor landing page). For example, if 20 vendor listings are provided in a host web site directory, bookmarking all of those 20 listed vendors would create the same generic icon design (be it a universal default or generic icon, a screen shot icon, etc.) for those bookmarks which would then appear as 20 graphically indistinct icons on, for example, the home screen of the user's computing device, even if each such graphically indistinct bookmark was individually identified (named) by the user before being added to the home screen.

Given the foregoing, what is needed are systems, methods, and computer program products which facilitate the ability of a user and/or vendor to create and/or obtain a unique, custom, and/or otherwise readily identifiable graphical representation icon to be displayed on a computing device in order to represent a selectable link, or “bookmark,” to a vendor landing page, web site, or web page.

### SUMMARY

This Summary is provided to introduce a selection of concepts in a simplified form that are further described below in the Detailed Description. This Summary is not intended to identify key features or essential features of the subject matter, nor is it intended to be used to limit the scope of the subject matter.

This disclosure addresses the above-described needs by providing systems, methods, and computing program products which facilitate the creation and/or generation of at least one readily identifiable icon that serves as a graphical representation of a selectable link, or “bookmark,” that directs the browser on a user computing device to a certain web page, web site, or other computational file.

In an aspect, the icons created and/or generated by the present disclosure may represent network addresses or uniform resource identifiers (URIs) indicative of various web pages, web sites, or other computational files associated with a vendor. An icon that is associated with a specific vendor may allow users to quickly and easily identify bookmarks to various types of information associated with that vendor, including the vendor's web site and/or specific web pages within the vendor's web site.

In some aspects, bookmark icons created and/or generated by the present disclosure may direct a browser to a vendor landing page. A vendor landing page may be a web site or web page contained within a searchable online directory comprising multiple web sites and/or web pages associated with a plethora of vendors. Each vendor landing page may comprise descriptions, reviews, location maps, menus, product listings, hours of operation, addresses, contact information, hyperlinks to relevant vendor web pages and/or web sites, and similar data associated with the various vendors contained within the online directory. Being listed in such online directory may allow a given vendor to be more easily located by users who opt to search the online directory rather than using standard browser search tools, such as the Google™ search engine provided by Google, Inc. headquartered in Mountain View, Calif.

### BRIEF DESCRIPTION OF THE DRAWINGS

The features and advantages of the present disclosure will become more apparent from the Detailed Description set forth below when taken in conjunction with the drawings in which like reference numerals indicate identical or functionally similar elements.

FIG. 1 is a schematic diagram which shows an illustrative system for facilitating the creation of a custom bookmarking icon for a computational file, in accordance with an aspect of the present disclosure.

FIG. 2 is a flowchart which shows an illustrative process for creating a custom bookmarking icon for a computational file, in accordance with an aspect of the present disclosure.

FIG. 3 is a screen capture of an exemplary host web site home page as shown on the display screen of a desktop computer, in accordance with an aspect of the present disclosure.

FIG. 4 is a screen capture of a host web site home page as shown on the display screen of a mobile computing device, in accordance with an aspect of the present disclosure.

FIG. 5 is a screen capture of a vendor landing page as shown on the display screen of a desktop computer, in accordance with an aspect of the present disclosure.

FIG. 6 is a screen capture of a vendor landing page as shown on the display screen of a mobile device, in accordance with an aspect of the present disclosure.

FIG. 7 is a screen capture of a vendor landing page showing a “pop-up window” with instructions as shown on the display screen of a mobile device, in accordance with an aspect of the present disclosure.

FIG. 8 is a screen capture of a screen display of a mobile device of a vendor landing page illustrating the creation of a custom icon for the selected vendor landing page, in accordance with an aspect of the present disclosure.

FIG. 9 is a screen capture of a screen display of a mobile device for allowing a user to name a created custom icon, in accordance with an aspect of the present disclosure.

FIG. 10 is a screen capture of a created custom icon added to the home screen of user's mobile device, in accordance with an aspect of the present disclosure.

FIG. 11 is a screen capture of a home screen of a user's mobile device showing the arrangement of a plurality of custom icons, in accordance with an aspect of the present disclosure.

FIG. 12 is a block diagram of an exemplary computing system useful for implementing aspects of the present disclosure.

### DETAILED DESCRIPTION

Where the definition of terms departs from the commonly used meaning of the term, applicant intends to utilize the definitions provided below, unless specifically indicated.

For the purpose of the present disclosure, the term “electronic device” refers to a device which is powered by a batter or other source of electricity which include at least one processor and which may be used electronically access the web pages. Electronic devices may include, for example, desktop computers, mobile devices such as portable computers, cellular phones, smartphones, tablets, and the like.

For the purposes of the present disclosure, the term “processor” refers to a device capable of, for example, executing instructions, implementing logic, calculating and storing values, analyzing or evaluating data, and the like. Exemplary processors may include application specific integrated circuits (ASIC), central processing units, microprocessors (e.g., for computers), such as, for example, microprocessors commercially available from Intel and AMD, and the like.

For the purposes of the present disclosure, the term “data processor” refers to a processor capable of, or used in, analyzing or evaluating data.

For the purpose of the present disclosure, the term “computer” refers to any type of computer system that implements software including an individual computer such as a personal computer, mainframe computer, mini-computer, and the like. In addition, computer system refers to any type of network of computers, such as a network of computers in a business, the Internet, personal data assistant (PDA), devices such as a cell phone, a television, a videogame console, a compressed audio or video player such as an MP3 player, a DVD player, a microwave oven, etc. A personal computer is one type of computer system that may include the following components: a case or chassis in a tower shape (desktop) and the following parts: motherboard, CPU, RAM, firmware, internal buses (PIC, PCI-E, USB, HyperTransport, CSI, AGP, VLB), external bus controllers (parallel port, serial port, USB, Firewire, SCSI. PS/2, ISA, EISA, MCA), power supply, case control with cooling fan, storage controllers (CD-ROM, DVD, DVD-ROM, DVD Writer, DVD RAM Drive, Blu-ray, BD-ROM, BD Writer, floppy disk, USB Flash, tape drives, SATA, SAS), video controller, sound card, network controllers (modem, NIC), and peripherals, including mice, keyboards, pointing devices, gaming devices, scanner, webcam, audio devices, printers, monitors, and the like.

For the purpose of the present disclosure, the term “in electronic communication” refers to two or more devices which are able to transmit electronic signals, data, and the like, by a wired connection, wireless connection, or a combination of wired and wireless connections.

For the purpose of the present disclosure, the terms “display device” and “display screen” refer to any device (e.g., a monitor) which presents visual images from a computer for viewing. The display device/display screen may be incorporated as a component of the computer, or may be a separate device which is in electronic communication with the computer.

For the purpose of the present disclosure, the term “home screen” refers to the initial primary (main) screen display of a computing device.

For the purpose of the present disclosure, the term “mobile device” refers to a device which is portable (i.e., which may be relatively easily carried) and which may include portable (i.e., laptop) computers, smartphones, tablets, other hand-held mobile devices, and the like.

For the purpose of the present disclosure, the term “smartphone” refers to a hand-held mobile device with more advanced computing capability and connectivity than basic feature phones, including and which may use mobile operating systems such as iOS, Android, BlackBerry operating systems, and the like. Smartphones may provide various features such as keyboards, touchscreens, personal digital assistants (PDAs), media players, a digital camera, web browsing, wireless connectivity (Wi-Fi), GPS navigation units, and the like.

For the purpose of the present disclosure, the term “device controller” refers to any combination of hardware and/or software which interacts with and controls the operation of a device such as, for example, a printer, video adapter, network card, sound card, and the like. Device controllers which comprise software may also function as “device drivers” (often referred to simply as “drivers”). Drivers simplify programming by acting as an interface between the hardware device and the applications or operating system using the device. Drivers often communicate with the device through, for example, the computer bus or communications subsystem to which the device hardware is connected.

For the purpose of the present disclosure, the term “data” refers to any information, signal, etc., which quantifies, describes, identifies, etc., an attribute, characteristic, property, etc., of a device, machine, equipment, component, parameter, variable, set of variables, etc.

For the purpose of the present disclosure, the term “software” refers to a general term used to describe any form of non-transitory programmed machine-readable language or instructions (e.g., object code) that, when loaded or otherwise installed, provides operating instructions to a machine capable of reading those instructions, such as a computer, smartphone, or other type of computer program reader. The term software may include (web) applications such as word processors, spreadsheets, etc., which perform productive tasks for users, system software such as operating system software (e.g., Windows, OS, Android, iOS, Linux, etc.) for both desktop and mobile electronic devices which interfaces with hardware to provide the necessary services for application software, device controllers (e.g., printer controllers such as printer drivers) which control the operation of devices such as display devices (e.g., monitors), printers, etc., and middleware which controls and co-ordinates distributed systems. Software may include programs, etc., that are coded by programming languages like C, C++, Java, JavaScript, HTML, XML, CSS, etc. Software is usually regarded as anything but hardware, meaning the “hard” are the parts that are tangible (able to hold) while the “soft” part is the intangible objects inside the computer. Software is so called to distinguish it from computer hardware, which encompasses the physical interconnections and devices required to store and execute (or run) the software. At the lowest level, software may comprise a machine language specific to an individual processor. A machine language comprises groups of binary values signifying processor instructions which change the state of the computer from its preceding state. Software may be stored or reside on, as well as be loaded or installed from, one or more floppy disks, CD ROM disks, hard disks (internal or external), or any other form of suitable non-volatile electronic storage medium.

Software may also be installed by downloading or by any other form of remote transmission.

For the purpose of the present disclosure, the term “web application” (also referred to herein interchangeably as “web app”) refers to application software which runs in a web browser or is created in a browser-supported programming language (such as a combination of JavaScript, HTML, CSS, etc.) and which relies upon a common web browser to run the application software.

For the purpose of the present disclosure, the term “application software” refers to software (e.g., bookmarking software, word processing software, etc.) which causes a computer to perform useful tasks (e.g., bookmarking software, word processing software, etc.) beyond the running of the computer itself (e.g., operating system software, etc.).

For the purpose of the present disclosure, the term “computer hardware” (hereafter referred to as “hardware”) refers to digital circuitry and physical devices of a computer system, as opposed to software, which may be stored on a hardware device such as a hard disk. Illustrative examples of hardware may include the motherboard, CPU, RAM, firmware, internal buses (PIC, PCI-E, USB, HyperTransport, CSI, AGP, VLB), external bus controllers (parallel port, serial port, USB, Firewire, SCSI. PS/2, ISA, EISA, MCA), the power supply, case control with cooling fan, storage controllers (CD-ROM, DVD, DVD-ROM, DVD Writer, DVD RAM Drive, Blu-ray, BD-ROM, BD Writer, floppy disks, USB Flash, tape drives, SATA, SAS), video controllers, sound cards, network controllers (modem, NIC), and other peripherals, including mice, keyboards, pointing devices, scanners, audio devices, printers, display devices (e.g., monitors), etc.

For the purpose of the present disclosure, the term “user” refers to an individual (or group of individuals) who are using embodiments of the present disclosure. The term user may also refer to a computer which inputs instructions to a computer system.

For the purposes of the present disclosure, the term “machine-readable medium” refers to any non-transitory medium or media on which may be read, for example, by a computer, or any other device capable of reading programmed machine-readable language or instructions. Examples of machine-readable media may include floppy disks, Zip™ disks, CD-ROM, CD-R, CD-RW, DVD, DVD-R, memory sticks, flash memory, hard disks (internal or external), optical disks, etc.

For the purposes of the present disclosure, the term “image” may refer to one or more pictures, one or more photos, one or more designs, one or more alphanumeric characters, etc., or any combination thereof, and which may be displayed on a display device (e.g., monitor, screen, etc.).

For the purpose of the present disclosure, the term “World Wide Web (WWW)” refers to a system of interlinked hypertext documents accessed via the Internet.

For the purposes of the present disclosure, the term “Internet” refers to a global system of interconnected computer networks that interchange data by packet switching using the standardized Internet Protocol Suite (TCP/IP). The Internet may carry various information resources and services, such as electronic mail, online chat, file transfer and file sharing, online gaming, and the inter-linked hypertext documents and other resources of the World Wide Web (WWW).

For the purpose of the present disclosure, the term “web document” refers to a web element (e.g., web page) having its own Uniform Resource Indicator (URI).

For the purpose of the present disclosure, the term “web page” refers to a web document which may be accessed by web browser, e.g., displayed on a monitor, a screen of a mobile device (e.g., portable computer, hand-held mobile device such as a smartphone, tablet, etc. The term “web page” may also refer to a computer file written, for example, markup language such as HTML.

For the purpose of the present disclosure, the terms “search engine” or “web search engine” refer to software which enables the user to search for information on the World Wide Web.

For the purpose of the present disclosure, the term “electronic search” (also referred to herein interchangeably as “online search” or “query”) refers to a search carried out using an electronic device (e.g., computer, hand-held mobile device, etc.) for online information via the Internet, a LAN, a WAN, etc., by imputing search criteria (e.g., alphanumeric characters with or without Boolean operators) to obtain search results, often using a web browser.

For the purpose of the present disclosure, the term “web browser” or “browser” refer interchangeably to software which retrieves, presents, traverses, etc., information resources on the Internet and the World Wide Web. Representative web browsers may include one or more of: Google Chrome, Mozilla Firefox, Internet Explorer (IE), Opera, Safari, etc.

For the purpose of the present disclosure, the terms “web directory” and “online directory” (also referred to herein interchangeably as “link directories”) refer to directories which list web sites by category and subcategory.

For the purpose of the present disclosure, the term “markup language” refers to any machine-readable language for annotating a document in a way that is syntactically distinguishable from text, images, etc., and which instructs software displaying the text, images, etc., to carry out appropriate actions.

For the purpose of the present disclosure, the term “Hyper Text Mark Up Language (HTML)” refers to the predominant markup language used for web pages and which provides a mechanism to create structured documents by denoting structural semantics for web page text such as headings, paragraphs, lists, links, quotes, etc. HTML allows images and objects to be embedded and may be used to create interactive forms. HTML may be written in the form of “HTML elements” comprising “tags” surrounded by angle brackets (“<” or “>”) within the web page content. HTML may load scripts in languages such as, for example, JavaScript which may affect the behavior of HTML web pages. HTML may also be used to include Cascading Style Sheets (CSS) to define the appearance and layout of the web page text and other material.

For the purpose of the present disclosure, the term “Extensible Mark Up Language (XML)” refers to is a markup language which defines a set of rules for encoding documents in a format which is both human-readable and machine-readable.

For the purpose of the present disclosure, the term “web site” generally refers to a web page or set of related web pages which may be served from a single web domain.

For the purpose of the present disclosure, the term “host web site” refers to a web site which hosts landing pages for vendors. A host web site may be an online directory for such vendors.

For the purpose of the present disclosure, the term “landing page” (also know interchangeably as a “lead capture page” or a “lander” refers to web page that appears in response to selecting (e.g., clicking on) a search engine optimized search result or an online advertisement. Landing pages may include reference landing pages (i.e., presents information that is relevant to the visitor and which can display text, images, dynamic compilations of relevant links, etc.), transactional landing pages (i.e., to persuade a visitor to take action by completing a transaction, such as by, for example, providing a form that needs to be filled out by the visitor), etc. The landing page may be displayed as directed sales copy and may be a logical extension of the advertisement, search result, link, etc.

For the purpose of the present disclosure, the term “bookmarked vendor's landing page” refers to a vendor landing page which has been stored on a user's device as bookmark.

For the purpose of the present disclosure, the term “pop-up window” refers to an electronic window which may be generated (triggered) automatically (i.e., “pops-up”), for example, during a browser search, by selecting a web page (e.g., landing page), etc.

For the purpose of the present disclosure, the term “pop-up window message” refers to any information (e.g., text, images, instructions, etc.) present in the pop-up window.

For the purpose of the present disclosure, the terms “automatic,” “automatically” and like terms refer to electronic elements such as “pop-up window,” bookmarks,” etc., which are generated, created, etc., responsively, for example, by software in response to, for example, a user accessing, selecting, without instructions, commands, etc., from the user.

For the purpose of the present disclosure, the term “vendor” refers to an individual or business which sells, distributes, markets, etc., products and/or services.

For the purpose of the present disclosure, the term “bookmark” (also known interchangeably as “favorites,” “Internet shortcuts,” etc.) refers to any Uniform Resource Identifier (URI) which may be stored (bookmarked) by the user on their device for later retrieval in any of various storage formats. Bookmarks may, for example, be accessed through, for example, a menu in the user's web browser.

For the purpose of the present disclosure, the terms “icon” and “computer icon” refer interchangeably to pictogram, symbol, etc., displayed on a device screen which may be used to activate software, document file, short cut, bookmark, etc.

For the purpose of the present disclosure, the terms “custom vendor icon bookmark” or simply “custom icon” refer to a bookmark in the form of an icon (“icon bookmark”) which is generated and/or created specifically for use with a particular bookmarked vendor landing page.

For the purpose of the present disclosure, the term “bookmarking software” refers to software which automatically generates a bookmark (short cut) in response to a request by a user to create a bookmark of a web page (e.g., vendor landing page).

The present disclosure is directed to systems, methods, and computer program products that allow a user to bookmark on a user's electronic computing (e.g., mobile) device a vendor's web landing page associated with a host web site in the form of a custom vendor icon bookmark, and particularly to generate a plurality of such generate distinct custom vendor icon bookmarks for addition to the home screen of the user's computing device.

In an aspect, the systems, methods, and computer program products of the present disclosure allow a user of a computing device, for example, to access a vendor landing page containing the vendor's information (e.g., vendor advertising, vendor products and/or services, etc.) associated with a host web site (and from one of many such vendor landing pages containing such vendor advertising, vendor products and/or services, etc.) and select a particular vendor landing page, whereupon the user will be prompted, for example, by a “pop-up window” (e.g., text bubble, text window, dialog box, etc.) as to whether the user wants to create a bookmark for that vendor landing page on the home screen of the user's device. If the user accepts and, for example, executes the instructions in the “pop-up window,” a custom vendor icon bookmark associated with that vendor may be automatically created on the home screen of the user's computing device to provide a distinct hyperlink to that vendor's landing page from the user's computing device for subsequent access. (In some aspects of the present disclosure, the user may also be provided with the ability to enter an alphanumeric identification for the custom vendor icon bookmark, such as the name of the vendor, etc.) Because each custom vendor icon bookmark on the home screen is distinct for that particular vendor, the user benefits in having a better chance of knowing which vendor's lending page the user is accessing when clicking on one of the custom vendor icon bookmarks on the home screen of the user's computing device. In addition, because some aspects of the present disclosure create a custom vendor icon bookmark when each vendor's landing page is accessed and then selected by the user, the vendor gets the benefit of, for example, visibly distinct and different advertising presence from the host web site.

In some aspects, components of the system of the present disclosure may comprise: a host web site located on a home web site computer; a plurality of vendor landing pages associated with the host web site, each vendor landing page containing vendor information and having one or more distinct custom vendor icons associated the vendor landing page; and bookmarking software located on the home web site computer which causes the home web site computer, in response to a user's computing device selecting at least one of the vendor landing pages, to automatically generate instructions for creating a custom vendor icon bookmark to be associated with the selected vendor landing page for addition to the user's computing device.

In some aspects, the method of the present disclosure for a user to create a custom vendor icon bookmark for one or more vendor landing pages on a user's electronic device for subsequent access of the distinctly bookmarked vendor landing pages may comprise the following steps: (a) providing a plurality of vendor landing pages associated with a host web site located on a home web site computer for access by a user with a user's computing device, each of the vendor landing pages containing vendor information and having one or more distinct custom vendor icons associated the vendor landing page, and wherein bookmarking software is located on the home web site computer to cause the home web site computer to automatically generate instructions for creating a distinct custom vendor icon bookmark to be associated with a vendor landing page selected by the user for addition to the user's electronic device; and (b) in response to the user selecting at least one of the plurality of vendor landing pages with the user's electronic device, the bookmarking software automatically generating instructions which are transmitted to the user's electronic device for creating a distinct custom vendor icon bookmark for addition to the user's electronic device.

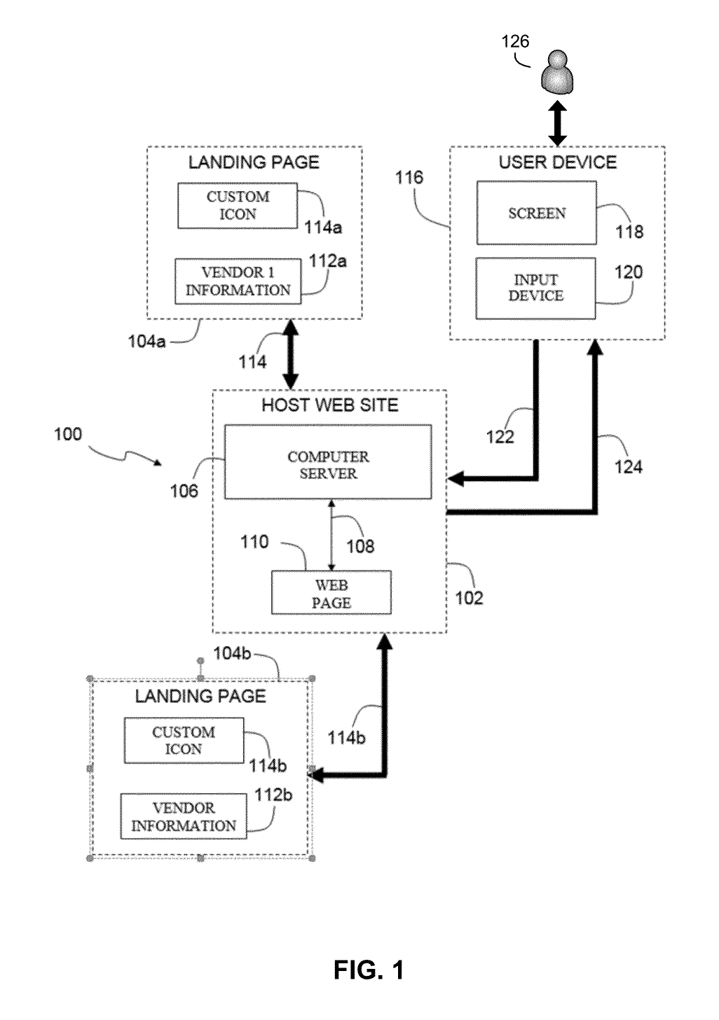

Referring now to FIG. 1, a schematic diagram which shows an illustrative system 100 for facilitating the creation of a custom bookmarking icon 114 for a computational file, in accordance with an aspect of the present disclosure, is shown.

In an aspect, system 100 may comprise a host web site 102, which includes a plurality of vendor landing pages 104 (shown as vendor landing pages 104a-b in FIG. 1). Host web site 102 may reside on at least one computer server 106. Computer server 106 may generate one or more various web pages 110 for host web site 102 as indicated by double headed arrow 108. In some aspects, web page 110 may comprise a web site home page which may comprise certain information regarding the web site, such as, by way of example and not limitation, the name of the owner of host web site 102, contact information for the owner of host web site 102, a brief description of the owner, products and/or services offered by the owner, reviews of the owner, a listing of one or more searchable categories by which to navigate host web site 102, a search box in which text may be entered to search host web site 102, one or more maps indicating the location of various vendors associated with host web site 102, a listing of one or more vendors associated with host web site 102, and any other relevant information as will be appreciated by those skilled in the relevant art(s) after reading the description herein. In some aspects, the listing of vendors associated with host web site 102 may comprise such vendors who were most recently added to web site 102, vendors who have been deemed to be most popular relative to the other vendors associated with web site 102, vendors who have been deemed to be most relevant to a given user 126 based on that user 126's search/browser history and/or previously identified interest, or any other organizational scheme as may be apparent to those skilled in the relevant art(s) after reading the description herein.

In an aspect, system 100 may further comprise landing pages 104 (shown as landing pages 104a-b in FIG. 1). Each landing page 104 may comprise vendor information 112 (shown as vendor information 112a-b in FIG. 1). Vendor information 112 may comprise various types of vendor-related data such as the name of the vendor, vendor contact information, vendor advertisements, one or more vendor descriptions, one or more maps visually depicting the vendor's location, one or more vendor reviews, one or more vendor menus, one or more vendor product lists, the vendor's hours of operation, the vendor's logo, and any similarly relevant information as may be recognized by those skilled in the relevant art(s) after reading the description herein. Additionally, each landing page 104 may have present thereon (as well as may be present on any one of web pages 110) a custom icon 114 (shown as custom icons 114a-b in FIG. 1). Each custom icon 114 may comprise a graphical representation that may be associated with the particular vendor that is associated with a given landing page 104 and may act as a “bookmark” for such landing page 104. As indicated by double headed arrows 114a-b, landing pages 104 are associated with and are electronically connected to host web site 102 and are controlled by computer server 106 via software that generates vendor information 112, custom icons 114, and the like.

System 100 may additionally comprise a user device 116. User device 116 may be a desktop computer, laptop computer, tablet, notebook computer, netbook computer, mobile computing device, smartphone, PDA, or any other similar computing device as will be recognized by those skilled in the relevant art(s) that is utilized by a user 126. User device 116 may comprise a display screen 118 which may be, for example, a home screen 1000 (not shown in FIG. 1) which is integral with user device 116 or which may be a separate display device (such as, by way of example and not limitation, a monitor). User device 116 may also include an input device 120 which may be in the form of a mouse, touchpad, touch screen, keyboard, joystick, audio intake component, or any similar element as may be appreciated by those skilled in the relevant art(s) after reading the description herein. Input device 120 may be integral with or separate from user device 116. As indicated by arrows 122 and 124, user device 116 may be in remote and/or direct electronic communication (e.g., via the Internet, a LAN, a WAN, etc.) with host web site 102. Initially, user device 116 may send a request (e.g., a search request) as shown by arrow 122 via, for example, a web browser. Based on the criteria submitted in request 122, host web site 102 and/or one or more landing pages 104 may end up in a “hits list” displayed (as indicated by arrow 124) on screen 118, or may be displayed directly on screen 118 if specifically part of request 122 made by user 126. By way of example and not limitation, request 122 may comprise the specific name and/or web address associated with host web site 102 or a landing page 104.

In some aspects, if user 126 selects (e.g., “clicks on”) one or more of landing pages 104, software on computer server 106, such as, by way of example and not limitation, bookmarking software, may generate, by way of example and not limitation, a “pop-up window” with instructions 706 (not shown in FIG. 1) for bookmarking the selected landing page(s) 108, and requesting user 126 to indicate whether or not they wish to create a bookmark for (e.g., create a “short cut” for subsequent retrieval of) the selected landing page(s) 108 on user device 116. If user 126 chooses to bookmark the selected landing page(s) 108, then, in response, the software on computer server 106 will create a distinct custom vendor icon bookmark in the form of a custom icon 114. Any created custom icon(s) 114 may be named by user 126 that created them and then added to screen 118 of user device 116, thereby facilitating the ability of user 126 to add to screen 118 such custom icons 114 as bookmarks, rather than just generic (and non-distinct) “screen shot” icons.

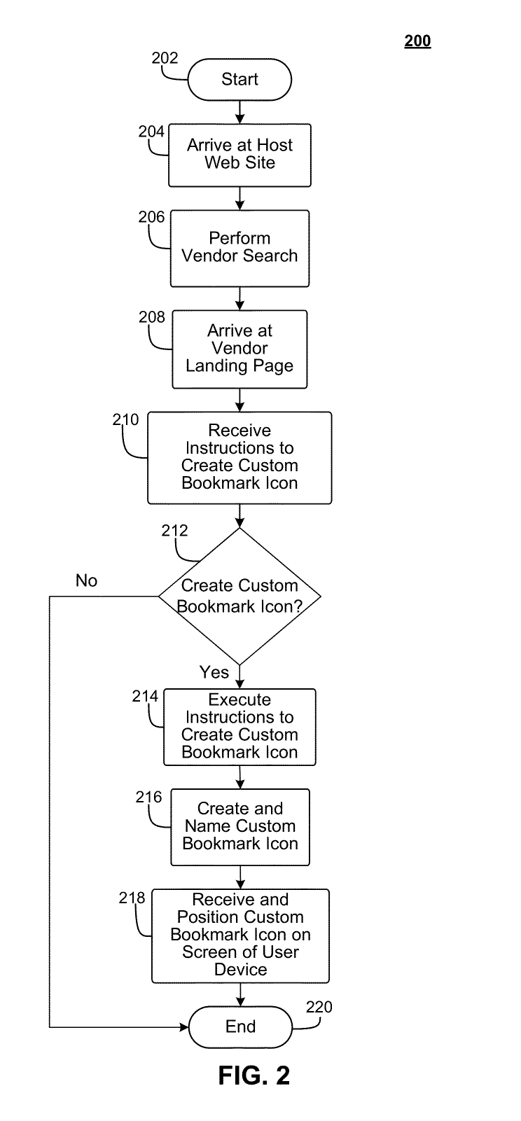

Referring now to FIG. 2, a flowchart which shows an illustrative process 200 for creating a custom bookmarking icon 114 for a computational file, in accordance with an aspect of the present disclosure, is shown.

Process 200, which may execute within system 100, begins at step 202 with control passing immediately to step 204.

At step 204, a user 126 arrives at host web site 102. In an aspect, host web site 102 comprises a searchable online directory that provides access to one or more landing pages 104 associated with various vendors and/or vendor businesses. User 126 may arrive at web site 102 in a multitude of ways, including, but not limited to, performing a web search using a browser search engine such as the Google™ search engine provided by Google, Inc. of Mountain View, Calif. for an online directory, searching for a vendor and/or vendor business associated with web site 102, or searching for web site 102 specifically. Additionally, user 126 may arrive at web site 102 by entering the web address for web site 102 into the web address bar of the web browser associated with user device 116.

At step 206, user 126 performs a vendor search. A vendor search may be performed, without limitation, by first selecting one of several categories displayed on the home page of host web site 102. Such categories may include, by way of example and not limitation, “activities,” “arts,” “automotive,” “beauty,” “destinations,” dining,” “entertainment,” “family friendly,” “fashion,” “health,” “home,” “local treasures,” “nightlife,” “parks,” “pet friendly,” “professional,” “recreation,” “shopping,” as well as any other similar categories as may be appreciated by those skilled in the relevant art(s) after reading the description herein. Upon selecting a given category, the browser associated with user device 116 may be directed to a web page that displays a listing of one or more links to vendor landing pages 104 associated with vendors that have goods and/or services relevant to that category. Such links may be displayed in a variety of ordering schemes, such as in order of proximity to user 126's current location, in order of determined relevance, in order of popularity, in order of predicted user 126 preference, in order of newness, in order of review rating, alphabetical order, or in any other appropriate order as may be apparent to those skilled in the relevant art(s) after reading the description herein. In some aspects, user 126 may opt to specify a particular geographic region in which to search for vendors before searching begins.

In some alternative aspects, a vendor search may be performed by utilizing a vendor search bar displayed on one or more pages of host web site 102, including the home page. One or more keywords or other text may be entered into the vendor search bar, including but not limited to vendor names, vendor descriptions, and categories for products and/or services. Upon user 126 entering text into the vendor search bar, system 100 may utilize software that is configured to interpret the text and generate a results list of relevant vendors in the form of links to vendor landing pages 104 in any of the ordering schemes set forth above.

In still some alternative aspects, a link to the vendor landing page 104 associated with the vendor that user 126 is searching for may appear in a listing on the web page of host web site 102 that user 126 is currently viewing, such as the home page. In such aspects, user 126 may simply select the link without performing any additional search functions.

At step 208, user 126 arrives at a given vendor landing page 104 that is associated with a link for a certain vendor that was selected at step 206. Vendor landing page 208 may comprise various information about the vendor, including the name of the vendor; vendor contact information; one or more vendor advertisements; one or more vendor descriptions; one or more maps visually depicting the vendor's location; one or more vendor reviews; one or more vendor menus; one or more vendor product lists; one or more links to more vendor information, such as the vendor's web site.; the vendor's hours of operation; the vendor's logo; and any similarly relevant information as may be recognized by those skilled in the relevant art(s) after reading the description herein.

At step 210, user 126 receives instructions 706 on how to create a custom bookmark icon for the vendor landing page 104 that is currently being viewed, as well as how to add the created bookmark icon to a certain location, such as home screen 1000 associated with user device 116. In some aspects, instructions 706 are presented immediately when user 126 arrives at vendor landing page 104. In some alternative aspects, instructions 706 are presented when user 126 engages with vendor landing page 104 in any way, such as, by way of example and not limitation, “clicking” or “tapping” on any portion of page 104. In still some further aspects, user 126 has to affirmatively indicate that user 126 desires to create a custom bookmark icon in order for instructions 706 to be presented. This may be done, for example, by selecting an option to create such custom bookmark icon, or by any similar method as may be apparent to those skilled in the relevant art(s) after reading the description herein. In some aspects, instructions 706 may be presented in the form of a “pop-up” window, within a new window of the browser, as a menu associated with “hovering” input device 120 over a certain location, or in any other form as may be apparent to those skilled in the relevant art(s) after reading the description herein.

In some aspects custom bookmark icon 114 may be created for any type of computational file as desired by user 126. Such computational file may be a web site, web page, data file, image file, program file, or any other similar retrievable site, page, image, or file as will be recognized by those skilled in the relevant art(s). By way of example and not limitation, user 126 may be car shopping. To facilitate the car shopping experience, user 126 may create a custom icon 114 for every web page that contains a car user 126 may be interested in purchasing, thereby facilitating faster and easier review of all potential car purchases at a later time. In still other aspects, the custom icon is created on user device or within an online directory by the associated vendor. That is, the vendor may provide a custom icon to system 100 which links to vendor landing page 104. Multiple vendor icons may be displayed to users, thereby creating an online directory having multiple vendor icons having vendor-provided imagery.

Instructions 706 for creating custom bookmark icons in these instances may be retrieved when user 126 affirmatively indicates that user 126 would like to create such icon, such as by selecting on option to do so. That option may be accessible as part of a menu, as part of a toolbar, or may be made available every time user 126 accesses a new web site, web page, image file, data file, program file, and the like. Instructions 706 may be presented in any of the forms given above. Additionally, in some aspects, instructions 706 may be generated by a software application downloaded onto user device 116 and continuously running thereon.

At step 212, user 126 decides whether or not to create custom icon 114 for which instructions 706 have been received. If the answer is in the affirmative, process 200 proceeds to step 214. If the answer is in the negative, process 200 proceeds to step 220.

At step 214, user 126 executes provided instructions 706 in order to create custom icon 114. Such instructions 706 may vary depending on type of user device 116 being used; however, no type of user device 116 is excluded from having the potential to create custom icon 114.

At step 216, custom icon 114 is created and named. In some aspects, custom icon 114 may be created automatically by system 100 based on system 100 determining an appropriate appearance for custom icon 114. Such determination may be made by software associated with system 100 analyzing one or more aspects of the computational file for which custom icon 114 is to be created, such as any logos or other images associated with the file. In some additional aspects, system 100 may automatically generate custom icon 114 based on one or more previously submitted designs or design templates submitted by an administrator of the computational file, such as the vendor owner if the file is associated with a vendor. In still some further aspects, user 126 may create, design, and or alter custom icon 114. By way of example and not limitation, user 126 may draw a desired icon 114, edit a provided icon 114 to make it more personal, or modify a template design for icon 114. In any case, once the appearance of custom icon 114 has been finalized, user 126 is given the opportunity to name it. In some aspects, the name may be presented proximate to icon 114 when icon 114 is displayed for later utilization by user 126, such as on screen 118 of user device 116.

At step 218, user 126 receives custom icon 114 upon user device 116 and is able to position icon 114 at a desired location for display upon screen 118. The position may be adjusted by “dragging” it, or by any other means as may be apparent to those skilled in the relevant art(s) after reading the description herein.

Process 200 then terminates at step 220. Process 200 may be repeated as many times as desired by user 126, thereby facilitating the creation of multiple custom icons 114.

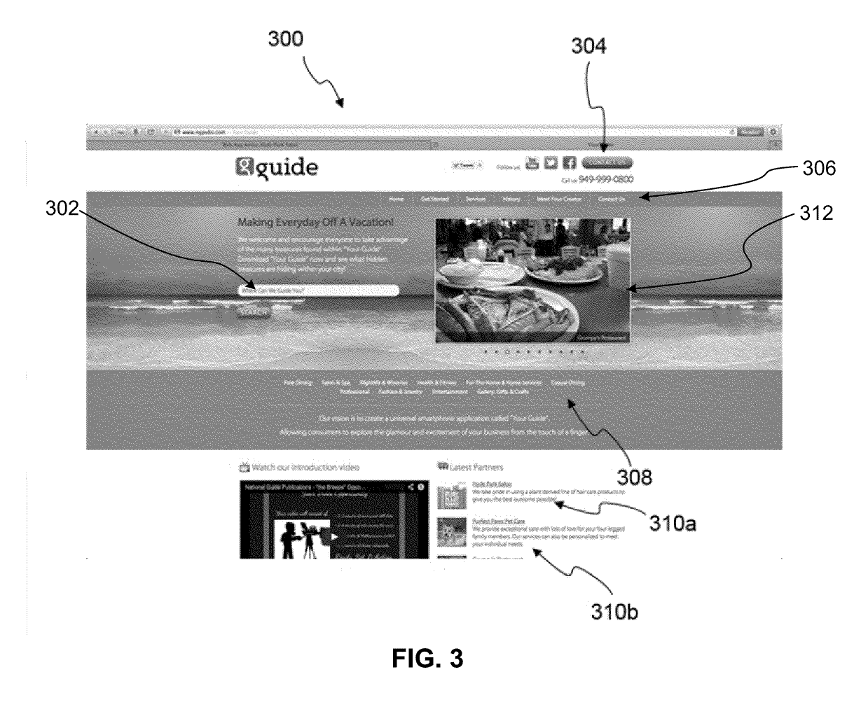

Referring now to FIG. 3, a screen capture of an exemplary host web site home page 300 as shown on the display screen 118 of a desktop computer, in accordance with an aspect of the present disclosure, is shown.

In some aspects, home page 300 comprises search box 302, host web site contact information 304, menu 306, category links 308, vendor landing page links 310 (shown as vendor landing page links 310a-b in FIG. 3), and vendor previews 312. Elements may be removed from and/or added to home page 300 without deviating from the scope of the present disclosure, as will be appreciated by those skilled in the relevant art(s) after reading the description herein.

Search box 302 may be configured to receive text from user 126. Upon receiving entered text, a search may be instigated by user 126 by either selecting an associated button or submitting an appropriate input via input device 120, or by any other similar means as recognized by those skilled in the relevant art(s). Once a search has been instigated, software associated with system 100 may interpret the entered text and identify one or more vendor landing pages 104 relevant to user 126's search.

Host web site contact information 304 may be provided via home page 300 to allow users 126 to submit feedback, make comments, ask for help, and the like. In some aspects, contact information 304 may comprise a listing of various ways to contact representatives of host web site 102, including one or more phone numbers, e-mail addresses, facsimile numbers, social media links, and the like. In some additional aspects, contact information 304 may comprise a selectable link, such as a button, that may be selected in order to direct the browser of user 126's user device 116 to some or all of host web site contact information 304.

Menu 306 may comprise various tools user 126 may select to interact with host web site 102. In some aspects, menu 306 may allow user 126 to quickly return to host web site home page 300, to quickly start the process of associating with host web site 102, to view a list of host web site 102 services, to learn about the history of host web site 102, to meet the creators of host web site 102, and to contact one or more representatives of host web site 102, as well as similar functions as may be apparent to those skilled in the relevant art(s) after reading the description herein.

Category links 308 may be provided to allow user 126 to browse vendors related to specific categories, including but not limited to “Fine Dining,” “Salon and Spa,” “Nightlife and Wineries,” “Health and Fitness,” “For the Home and Home Services,” “Casual Dining,” “Professional,” “Fashion and Jewelry,” “Entertainment,” “Gallery. Gifts, and Crafts,” as well as similar categories that may be apparent to those skilled in the relevant art(s) after reading the description herein.

Vendor landing page links 310 may comprise a brief list of links to certain vendor landing pages 104 for quick and easy access. Vendor landing page links 310 displayed on home page 300 may represent those vendors that have been most recently added to the online directory provided by host web site 102, those vendors that have been deemed most popular, those vendors that have been deemed most relevant to user 126 based on previous searches and/or preferences, those vendors that have been deemed most interesting to user 126 based on previous browsing history, or vendors selected for any other rationale.

Vendor previews 312 may comprise images and/or texts of the various vendors associated with host web site 302.

In some aspects, host web site 302 may comprise a map view option. The map view option may allow user 126 to view the geographical location of all the vendors associated with host web site 302 within a certain radius.

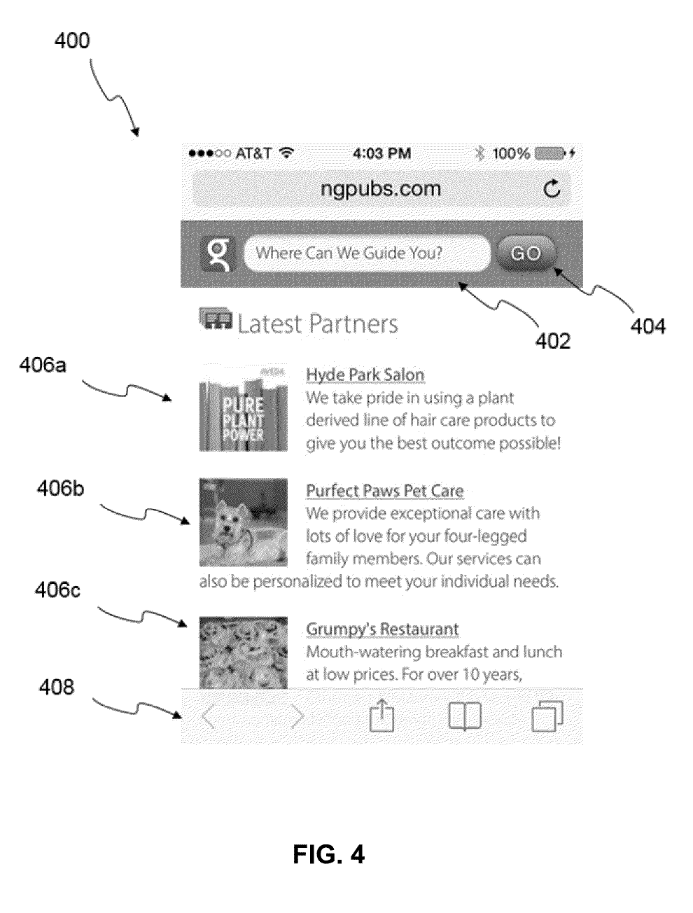

Referring now to FIG. 4, a screen capture of a host web site home page 400 as shown on the display screen 118 of a mobile computing device, in accordance with an aspect of the present disclosure, is shown.

In some aspects, home page 400 may comprise search box 402, which functions substantially similarly to search box 302; search instigation button 404, which instigates searches substantially similarly to the way searches are instigated via home page 300; as well as vendor landing page links 406 (shown as vendor landing page links 406a-c in FIG. 4), which function substantially similar to vendor landing page links 310 of home page 300.

Home page 400 may further comprise tool bar 408. Tool bar 408 may comprise various tools and/or buttons that perform various functions in accordance with the operating system of the given mobile device. While home page 400 and tool bar 408 are shown in the exemplary form as what would be displayed upon the screen of an iPhone® provided by Apple, Inc. of Cupertino, Calif., any mobile device may be used in accordance with the present disclosure, wherein any given mobile device may comprise its own unique home page and toolbar configuration.

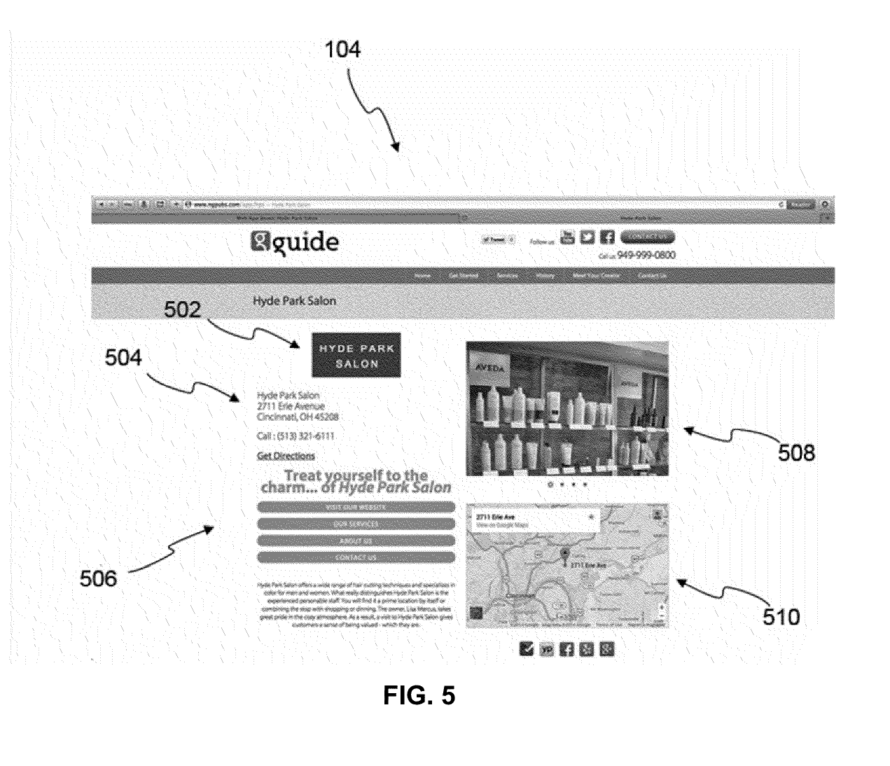

Referring now to FIG. 5, a screen capture of a vendor landing page 104 as shown on the display screen 118 of a desktop computer, in accordance with an aspect of the present disclosure, is shown.

When displayed on screen 118 of a desktop computer, vendor landing page 104 may comprise vendor name 502, vendor contact information 504, vendor details 506, one or more vendor pictures 508, and one or more vendor location maps 510.

In some aspects, vendor details 506 may comprise one or more vendor descriptions; one or more vendor reviews; one or more vendor menus; one or more vendor product lists; one or more links to more vendor information, such as the vendor's web site.; the vendor's hours of operation; and any similarly relevant information as may be recognized by those skilled in the relevant art(s) after reading the description herein.

In some aspects, vendor pictures 508 may be presented on vendor landing page 104 as a slide show. Vendor pictures 508 may scroll automatically after a certain period of time, or user 126 may scroll through pictures 508 manually. Engaging a picture 508 such as by clicking and/or tapping on it may cause a link to a larger version of picture 508 to be activated.

Vendor location maps 510 may allow user 126 to view the location of a certain vendor on a map, as well as determine how to get to the vendor. Engaging a map 510 such as by clicking and/or tapping on it may cause a link to a larger version of map 510 to be activated, such larger version of map 510 comprising interactive features such as zooming, panning, and the like.

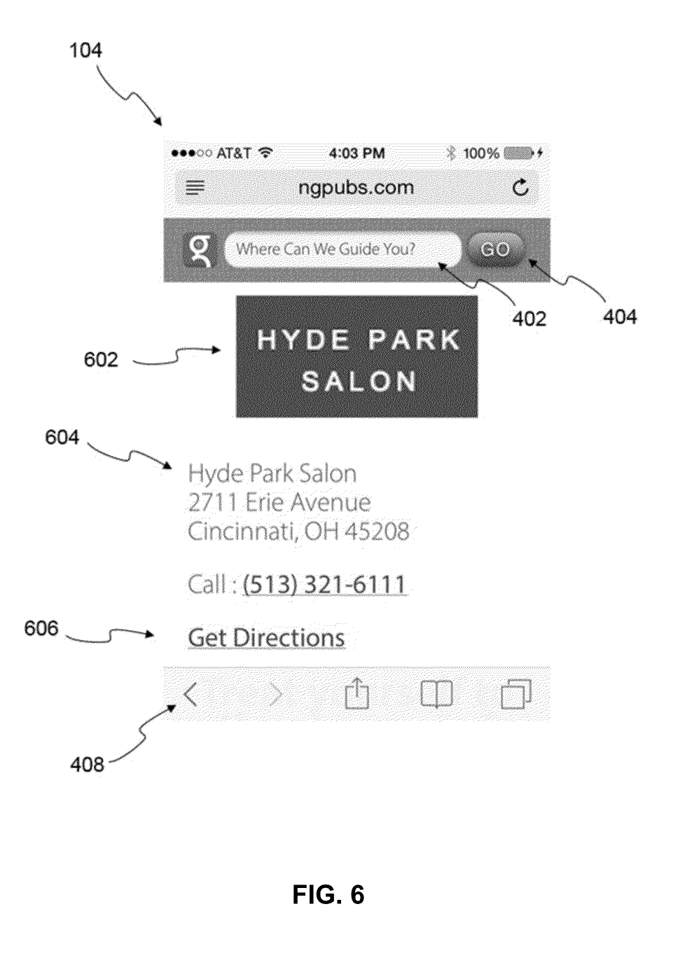

Referring now to FIG. 6, a screen capture of a vendor landing page 104 as shown on the display screen 118 of a mobile device, in accordance with an aspect of the present disclosure, is shown.

When displayed on screen 118 of a mobile device, vendor landing page 104 may comprise vendor name 602, which corresponds to vendor name 502 associated with the desktop computer; vendor contact information 604, which corresponds to vendor contact information 504 associated with the desktop computer; and vendor directions link 606. Vendor directions link 606 may be selected in order to direct the operating system and/or browser of the mobile device to an application and/or web site at which directions to the vendor may be obtained.

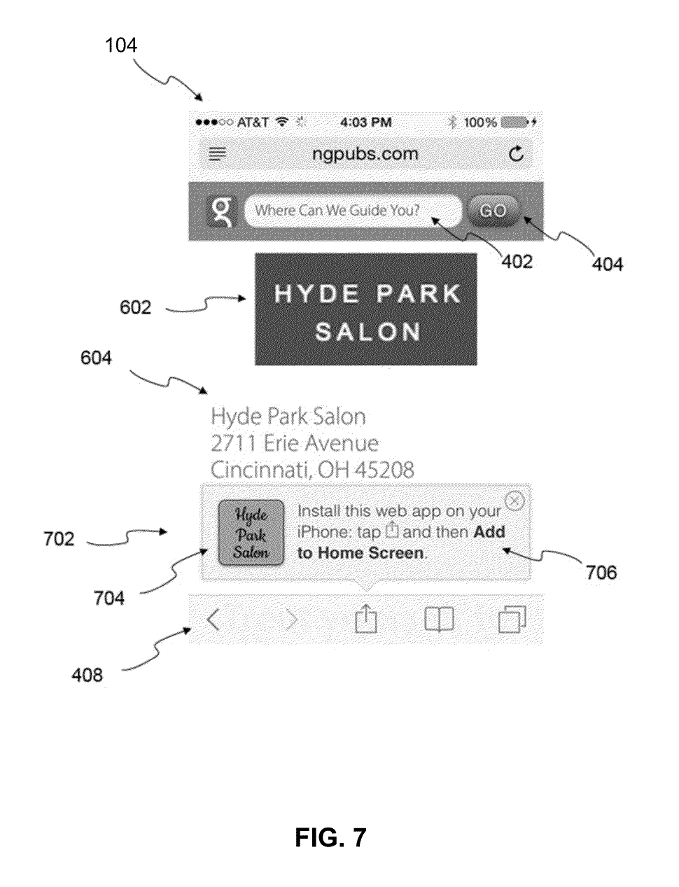

Referring now to FIG. 7, a screen capture of a vendor landing page 104 showing a “pop-up window” 702 with instructions 706 as shown on the display screen 118 of a mobile device, in accordance with an aspect of the present disclosure, is shown.

In an aspect, when user 126 accesses vender landing page 104, user 126 may be presented with pop-up window 702 which comprises one or more instructions 706 for creating custom icon 114 and adding it to home screen 1000 (not shown in FIG. 7) and/or another location associated with user device 116.

In some aspects, pop-up window 702 may be presented to user 126 automatically upon arriving at vendor landing page 104. In some alternative aspects, pop-up window 702 may be presented to user 126 upon user 126 affirmatively indicating that user 126 would like to create a bookmark for vendor landing page 104. In yet some additional alternative aspects, pop-up window 702 may be accessible from a menu or toolbar, or may be presented to user 126 every time user 126 accesses a new web site, web page, image, data file, or other similar computational file. In such aspects, pop-up window 702 and associated instructions 706 may be part of a software application that is downloadable and continuously running within computing device 116.

In some aspects, instructions 706 are not presented via pop-up window 702. In such aspects, instructions 706 may be presented to user 126 via a menu or toolbar, within a new window within a browser associated with user device 116, as part of a display window associated with “hovering” a graphical representation of input device 120 on screen 118 over a certain icon, button, or other symbol. Such hovering is known by those skilled in the relevant art(s).

In some aspects, custom icon 114 may be automatically created by user device 116 based on, for example, part of the design of vendor landing page 104, a logo associated with the vendor, or a template previously submitted by the vendor. In some additional aspects, custom icon 114 may be previously submitted in a completed form by the vendor. In yet some additional aspects, custom icon 114 may be modifiable or customizable by user 126; or, user 126 may design and/or create custom icon 114 completely from scratch. In such aspects wherein user 126 creates, modifies, and/or customizes icon 114, user 126 may use one or more software products designed for such purposes and/or user 126 may upload and/or scan previously created images to be used as icon 114.

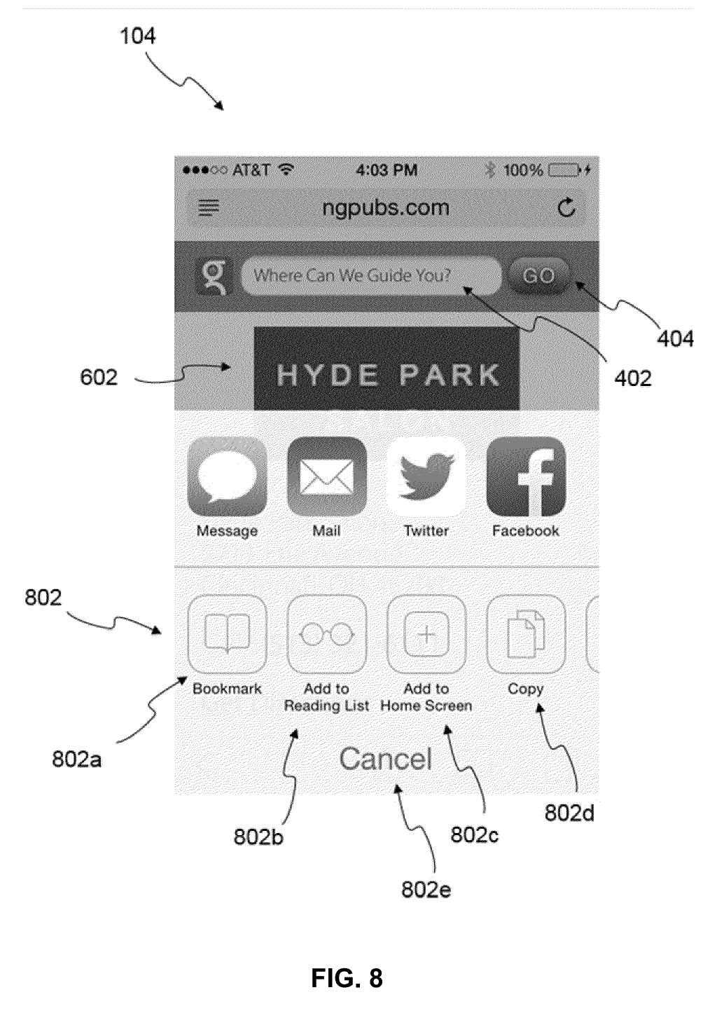

Referring now to FIG. 8, a screen capture of a screen display 118 of a mobile device of a vendor landing page 104 illustrating the creation of custom icon 104 for selected vendor landing page 104 after user 126 follows instructions 706, in accordance with an aspect of the present disclosure, is shown.

In aspects wherein user device 116 is an iPhone®, user 126 may be directed by instructions 706 to utilize button 802c within button set 802 (shown collectively as buttons 802a-e in FIG. 8) in order to add custom icon 114 to home screen 1000 (not shown in FIG. 8) of user device 116. Although an iPhone® screen 118 is shown in FIG. 8 for exemplary purposes, those skilled in the relevant art(s) would appreciate that instructions 706 may guide user 126 through the process of adding custom icon 114 to home screen 1000 or other portion of any user device 116 running on any operating system.

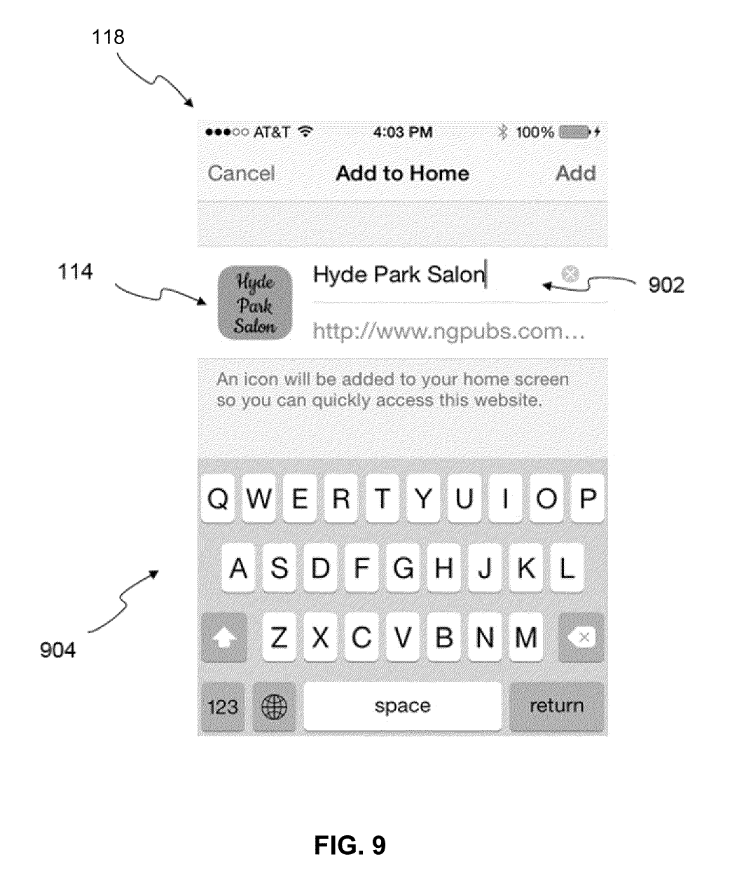

Referring now to FIG. 9, a screen capture of a screen display 118 of a mobile device for allowing user 126 to name a created custom icon 114, in accordance with an aspect of the present disclosure, is shown.

In some aspects, after custom icon 126 has been created and is ready to be added to home screen 1000 (not shown in FIG. 9) of user device 116, user 126 may be given the option to name icon 114. In some aspects, user 126 may be presented with text entry box 902 wherein a name for custom icon 114 may be entered utilizing keypad 904. As will be apparent by those skilled in the relevant art(s) after reading the description herein, other input devices besides keypad 904 may be used, including any input device 120.

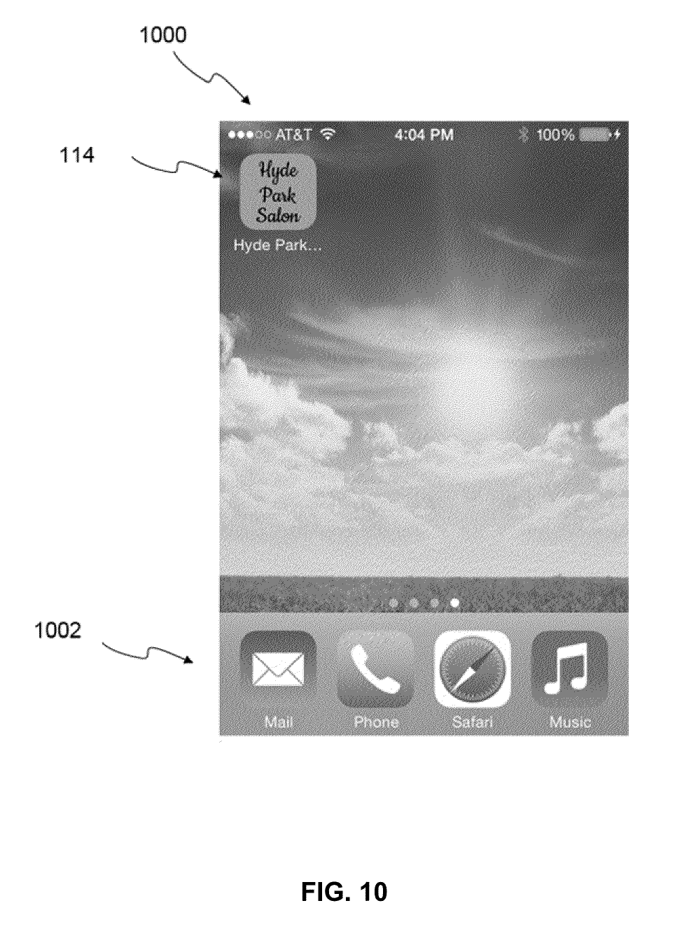

Referring now to FIG. 10, a screen capture of a created custom icon 114 added to the home screen 1000 of user 126's mobile device, in accordance with an aspect of the present disclosure, is shown.

Custom icon 114 may be displayed on home screen 1000 of user device 116 along with other icons 1002 utilized via device 116. In some aspects, custom icon 114 may be displayed adjacent to the name that was assigned to it by user 126.

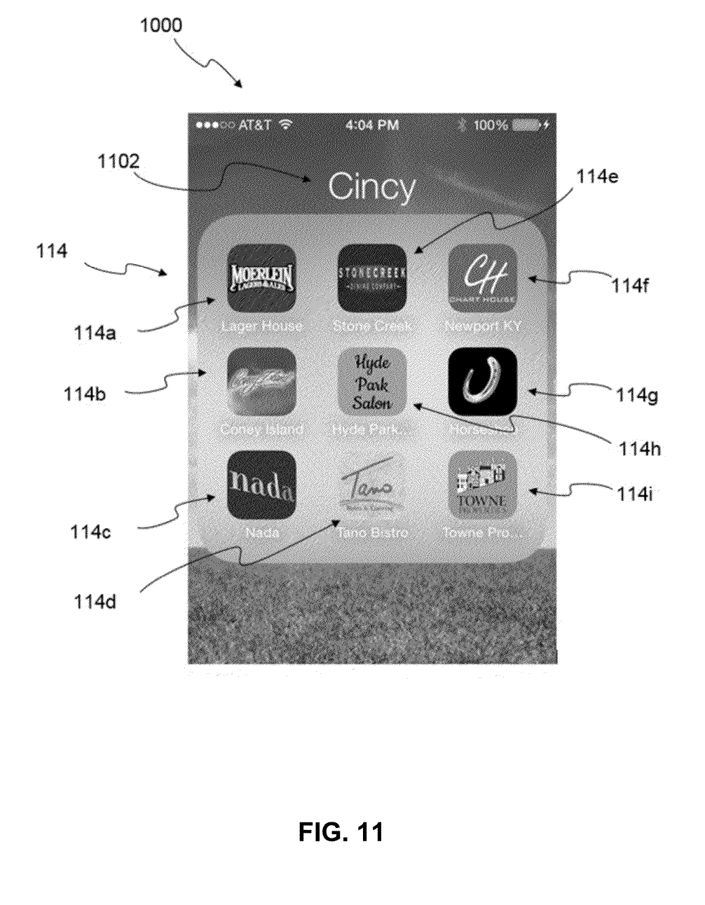

Referring now to FIG. 11, a screen capture of home screen 1000 of user 126's mobile device showing the arrangement of a plurality of custom icons 114, in accordance with an aspect of the present disclosure, is shown.

Multiple custom icons 114 (shown as custom icons 114a-i in FIG. 11) may be added to home screen 1000 of user device 116. In some aspects, custom icons 114 may be arranged in a group for convenience, especially when custom icons 114 are related in some way. By way of example and not limitation, a group could be created for a group of icons 114 that are all associated with vendors related to recreation. In some aspects, any group of icons 114 may be assigned a name 1102.

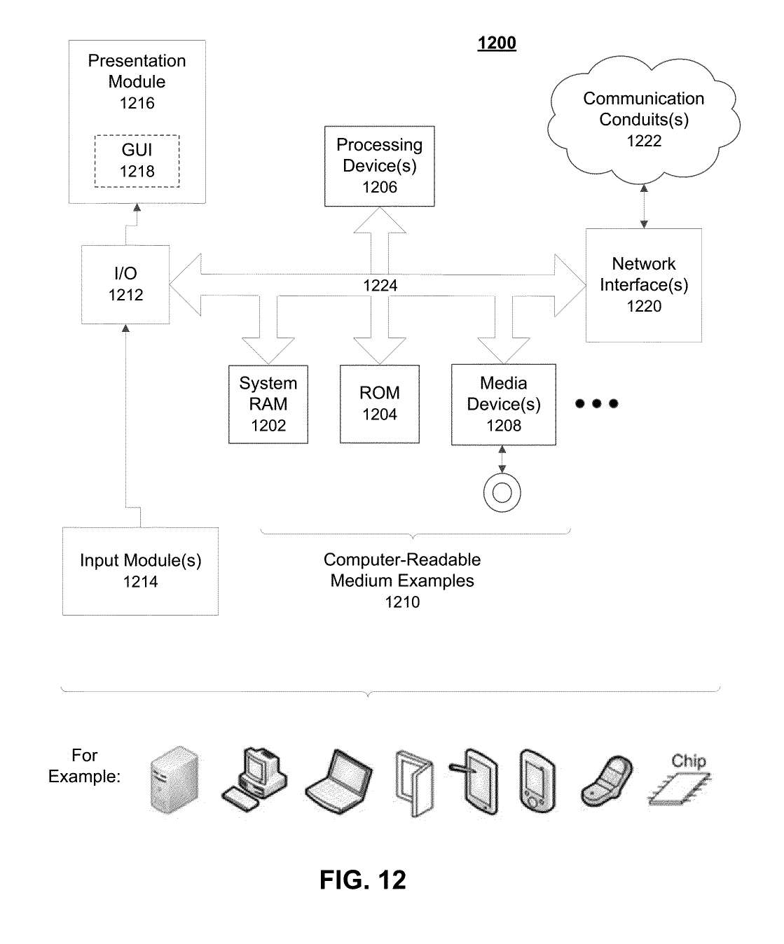

Referring now to FIG. 12, a block diagram of an exemplary computing system 1200 useful for implementing aspects of the present disclosure, is shown.

FIG. 12 sets forth illustrative computing functionality 1200 that may be used to implement any component of the present disclosure. In all cases, computing functionality 1200 represents one or more physical and tangible processing mechanisms.

Computing functionality 1200 may comprise volatile and non-volatile memory, such as RAM 1202 and ROM 1204, as well as one or more processing devices 1206 (e.g., one or more central processing units (CPUs), one or more graphical processing units (GPUs), and the like). Computing functionality 1200 also optionally comprises various media devices 1208, such as a hard disk module, an optical disk module, and so forth. Computing functionality 1200 may perform various operations identified above when the processing device(s) 1206 execute(s) instructions that are maintained by memory (e.g., RAM 1202, ROM 1204, and the like).

More generally, instructions and other information may be stored on any computer readable medium 1210, including, but not limited to, static memory storage devices, magnetic storage devices, and optical storage devices. The term “computer readable medium” also encompasses plural storage devices. In all cases, computer readable medium 1210 represents some form of physical and tangible entity. By way of example, and not limitation, computer readable medium 1210 may comprise “computer storage media” and “communications media.”

“Computer storage media” comprises volatile and non-volatile, removable and non-removable media implemented in any method or technology for storage of information, such as computer readable instructions, data structures, program modules, or other data. Computer storage media may be, for example, and not limitation, RAM 1202, ROM 1204, EEPROM, Flash memory, or other memory technology, CD-ROM, digital versatile disks (DVD), or other optical storage, magnetic cassettes, magnetic tape, magnetic disk storage, or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared, and other wireless media. Combinations of any of the above are also included within the scope of computer readable medium.

Computing functionality 1200 may also comprise an input/output module 1212 for receiving various inputs (via input modules 1214), and for providing various outputs (via one or more output modules). One particular output module mechanism may be a presentation module 1216 and an associated GUI 1218. Computing functionality 1200 may also include one or more network interfaces 1220 for exchanging data with other devices via one or more communication conduits 1222. In some embodiments, one or more communication buses 1224 communicatively couple the above-described components together.

Communication conduit(s) 1222 may be implemented in any manner (e.g., by a local area network, a wide area network (e.g., the Internet), and the like, or any combination thereof). Communication conduit(s) 1222 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The terms “module” and “component” as used herein generally represent software, firmware, hardware, or combinations thereof. In the case of a software implementation, the module or component represents program code that performs specified tasks when executed on a processor. The program code may be stored in one or more computer readable memory devices. The features of the present disclosure described herein are platform-independent, meaning that the techniques can be implemented on a variety of commercial computing platforms having a variety of processors (e.g., set-top box, desktop, laptop, notebook, tablet computer, personal digital assistant (PDA), mobile telephone, smart telephone, gaming console, and the like).

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein). As will be appreciated by those skilled in the relevant art(s) after reading the description herein, certain features from different aspects of the devices and computer program products of the present disclosure may be combined to form yet new aspects of the present disclosure.

What is claimed is:

1. A computer-implemented method for facilitating the creation of a custom graphical representation of a hyperlink to at least one computational file, the method comprising the steps of:
(a) receiving, via a graphical user interface associated with a user computing device, an indication that a user desires to store a hyperlink to at least one computational file for later retrieval;
(b) presenting, via the graphical user interface associated with the user computing device, at least one instruction to the user for how to create a custom graphical representation of the hyperlink to the at least one computational file;
(c) determining that the user has executed the at least one presented instruction;
(d) generating the custom graphical representation of the hyperlink to the at least one computational file; and
(e) presenting the custom graphical representation of the hyperlink to the at least one computational file to the user via the graphical user interface associated with the user computing device.

2. The method of claim 1, wherein the at least one computational file is a vendor landing page.

3. The method of claim 2, wherein the vendor landing page is associated with on online vendor directory comprising multiple vendor landing pages.

4. The method of claim 2, wherein the custom graphical representation is at least partially created by at least one of: the user and a vendor associated with the vendor landing page.

5. The method of claim 1, wherein the custom graphical representation is completely generated by the user computing device.

6. The method of claim 1, further comprising the step of:
(f) storing the custom graphical representation on the home screen of the user computing device.

7. The method of claim 1, further comprising the steps of:
(f) presenting, via the graphical user interface, a text box to the user; and
(g) receiving, via at least one input device associated with the user computing device, textual content indicative of a name to be associated with the custom graphical representation.

8. The method of claim 1, wherein the indication that the user desires to store a hyperlink to at least one computational file for later retrieval comprises the user taking at least one affirmative step to store the hyperlink.

9. The method of claim 1, wherein the indication that the user desires to store a hyperlink to at least one computational file for later retrieval comprises the user accessing the at least one computational file.

10. A system for facilitating the creation of a custom graphical representation of a hyperlink to at least one computational file, comprising:
(a) at least one web server capable of providing a graphical user interface, via a communications network, to a plurality of computing devices, the plurality of computing devices configured to communicate with at least one of: a vendor and a user; and
(b) at least one application server, communicatively coupled to the at least one web server via the communications network, the at least one application server comprising:
(i) a user input reception collection service capable of receiving from the user an indication that the user desires to store a hyperlink to at least one computational file for later retrieval;
(ii) an instruction creation service capable of presenting at least one instruction to the user for how to create a custom graphical representation of the hyperlink to the at least one computational file;
(iii) a custom graphical representation service capable of determining that the user has executed the at least one presented instruction and generating the custom graphical representation of the hyperlink to the at least one computational file and presenting the custom graphical representation of the hyperlink to the at least one computational file to the user via a user computing device.

11. The system of claim 10, wherein the at least one computational file is a vendor landing page and the vendor landing page is associated with on online vendor directory comprising multiple vendor landing pages.

12. The system of claim 11, wherein the custom graphical representation is created by an associated vendor.

13. The system of claim 11, wherein the online vendor directory presents to the user information about a plurality of vendor including associated custom graphical representations.

14. A computer-implemented method for facilitating the creation and operation of an online directory presented on a host website, the online directory having a plurality of custom graphical representations of a hyperlink to at least one computational file for each vendor linked by the online directory, the method comprising the steps of:
(a) receiving, at a host website, a custom icon image and vendor information from a plurality of vendors;
(b) creating, by a computing device, for each of the plurality of vendors, a computational file containing a vendor landing page, the vendor landing page comprising vendor contact information;
(c) creating, by the computing device, for each of the plurality of vendors, a custom graphical representation comprising an icon incorporating the custom icon image;
(d) updating the online directory with the created custom graphical representations; and
(e) linking the created custom graphical representations to the created computational files;
wherein each vendor is represented within the online directory by the associated custom graphical representation.

15. The method of claim 14, wherein the custom icon image is received from the associated vendor.

16. The method of claim 15, wherein the vendor contact information further comprises:
a map indicating the vendor location;
a vendor services description; and
vendor hours of operation.

17. The method of claim 14, further comprising the step of:
(f) presenting, via a user computing device, the online directory.

18. The method of claim 17, wherein the user computing device is a mobile device.

19. The method of claim 18, further comprising the step of:
(g) storing the custom graphical representation on a home screen of the user computing device.

20. The method of claim 19, further comprising the steps of:
(h) receiving, from the vendor, a sales promotion; and
(i) presenting, via the mobile device, the sales promotion to the user.
